(19) United States
(12) Patent Application Publication
(10) Pub. No.: US 2006/0114995 A1
(43) Pub. Date: Jun. 1, 2006

(54) Method and system for high speed video encoding using parallel encoders

(76) Inventors: Joshua Robey, Hollis, NH (US); Roy F. Knight, Pelham, NH (US); Paul Douglas Grearson, Andover, MA (US)

Correspondence Address: MCANDREWS HELD & MALLOY, LTD, 500 WEST MADISON STREET, SUITE 3400, CHICAGO, IL, 60661, US

(21) Appl. No.: 11/001,473

(22) Filed: Dec. 1, 2004

(51) Int. Cl. H04N 7/12; H04N 11/04; H04B 1/66; H04N 11/02

(52) U.S. Cl. 375/240.12; 375/240.15

(57) ABSTRACT

In a video processing system, a method and system for high speed video encoding using parallel encoders are provided. A delimiter may break up a video sequence into encoding groups that are transferred to a plurality of parallel encoders. The parallel encoders may process and transfer intra-coded pictures in the encoding groups to previous parallel encoders or may process and transfer last predictive pictures to next parallel encoders. When intra-coded pictures are transferred, the encoding group may correspond to that of a GOP structure. When predictive pictures are transferred, the encoding group may end in at least one bidirectional-predictive picture. The parallel encoders process the transferred intra-coded pictures or transferred predictive pictures to generate a plurality of parallel outputs. An assembler assembles an encoded video output from the parallel outputs based on timing information. A controller controls the operation of the delimiter, the parallel encoders, and the assembler.

### CROSS-REFERENCE TO RELATED APPLICATIONS/INCORPORATION BY REFERENCE

Not applicable.

### FIELD OF THE INVENTION

Certain embodiments of the invention relate to the compression of video signals. More specifically, certain embodiments of the invention relate to a method and system for high speed video encoding using parallel encoders.

### BACKGROUND OF THE INVENTION

In video compression systems, a source video sequence may be partitioned into successive groups of pictures or GOPs, where each GOP picture may be of a pre-defined picture coding type. These picture coding types may comprise intra-coded pictures, predicted pictures, and bidirectional-predicted pictures. The intra-coded or “I” pictures may only use the information within the picture to perform video compression. These self-contained “I” pictures provide a base value or anchor frame that is an estimate of the value of succeeding pictures. Each GOP may generally start with a self-contained “I” picture as the reference or anchor frame from which the other pictures in the group may be generated for display. The GOP frequency, and correspondingly the frequency of “I” pictures, may be driven by specific application spaces. The predicted or “P” pictures may use a motion estimation scheme to generate picture elements that may be predicted from the most recent anchor frame or “I” picture. Compressing the difference between predicted samples and the source value results in better coding efficiency than that which may be achieved by transmitting the encoded version of the source picture information. At a receiver or decoder side, the compressed difference picture is decoded and subsequently added to a predicted picture for display.

Motion estimation may refer to a process by which an encoder estimates the amount of motion for a collection of picture samples in a picture “P”, via displacing another set of picture samples within another picture. Both sets of picture samples may have the same coordinates within their corresponding pictures and the displacing may be performed within a larger group of picture samples labeled a motion window. Minimizing the difference between the two sets of picture samples motivates motion estimation. A displaced set of picture samples corresponding to a minimum difference may be considered the best prediction and may be distinguished by a set of motion vectors. Once all the motion vectors are available, the whole picture may be predicted and subtracted from the samples of the “P” picture. The resulting difference signal may then be encoded.

Motion compensation may refer to a process by which a decoder recalls a set of motion vectors and displaces the corresponding set of picture samples. Output samples may be decoded or reconstructed by adding the displaced samples to a decoded difference picture. Because it may be desirable to produce a drift-free output stream, both the encoder and the decoder need access to the same decoded pictures in order to utilize the decoded pictures as basis for estimation of other pictures. For this purpose, the encoder may comprise a copy of the decoder architecture to enable the duplication of reconstructed pictures. As a result, the final motion estimation and final displacement may be done on reconstructed pictures.

Since both the “I” pictures and the “P” pictures may be used to predict pixels, they may be referred to as “reference” pictures. The bidirectional-predicted pictures or “B” pictures may use multiple pictures that occur in a future location in the video sequence and/or in a past location in the video sequence to predict the image samples. As with “P” pictures, motion estimation may be used for pixel prediction in “B” pictures and the difference between the original source and the predicted picture may be compressed. At the receiver or decoder end, one or more “B” pictures may be motion compensated and may be added to the decoded version of the compressed difference signal for display.

FIG. 1 illustrates an exemplary sequence of pictures to be encoded, indicating the location of GOP boundaries, picture coding types, and dependencies between picture coding types. Referring to FIG. 1, an exemplary GOP structure 100 in a video sequence may comprise, but need not be limited to, twelve (12) pictures: I₂, B₃, B₄, P₅, B₆, B₇, P₈, B₉, B₁₀, P₁₁, B₁₂, and B₁₃, where picture I₂ is the first picture and picture B₁₃ is the last picture in the GOP structure 100 respectively. The GOP structure 100 in the video sequence may comprise fewer or more than the exemplary 12 pictures shown in FIG. 1. The length of a current GOP in the video sequence may be delimited by a start current GOP boundary located before the occurrence of picture I₂ and an end current GOP boundary located after the occurrence of picture B₁₃. The length, picture ordering, and/or prediction dependencies shown in FIG. 1 are illustrative of the exemplary GOP structure 100 and may vary according to specific applications and/or on system requirements.

Arrows may indicate prediction dependencies between pictures of various picture coding types in FIG. 1. For example, arrows pointing to picture I2 sow prediction dependencies of pictures B0, B1, B3, B4, and P5 on picture I2 in the current GOP. Similarly, arrows pointing to picture I14 indicate prediction dependencies of pictures P11, B12, B13, B15, B16, and P17 on picture I14, where picture I14 is located in the next GOP. Prediction dependencies may cross over the start current GOP boundary and the end current GOP boundary to pictures in the previous GOP and in the next GOP respectively. In this regard, the last picture in the current GOP that does not have a prediction dependency to a picture in the next GOP is picture P₁₁, where picture P₁₁ in the current GOP corresponds to the last “P” picture in the GOP structure 100. Similarly, the only pictures in the current GOP that have a prediction dependency to a picture in the next GOP are pictures B₁₂ and B₁₃, where pictures B₁₂ and B₁₃ in the current GOP correspond to “B” pictures that occur after the last “P” picture in the GOP structure 100.

Because prediction dependencies of “B” pictures may occur across GOP boundaries, encoders may generally process GOPs in their order of occurrence in the video sequence to provide the appropriate dependencies to pictures in subsequent GOPs. For example, an encoder may first encode pictures in the previous GOP, followed by pictures in the current GOP, and then pictures in the next GOP. However, the encoding of pictures B₀ and B₁ in the previous GOP may require the encoder to obtain information from the encoding of picture I₂ in the current GOP, while the encoding of pictures B₁₂ and B₁₃ in the current GOP may require the encoder to obtain information from the encoding of picture I₁₄ in the next GOP. The encoder architecture, for example, may need to provide for the encoding and reconstruction of picture I₂ to utilize picture I₂ as a basis for estimating pictures B₀ and B₁. Similarly, the encoder architecture may need to provide for the encoding and the reconstruction of picture I₁₄ to utilize picture I₁₄ as a basis for estimating pictures B₁₂ and B₁₃. The encoder architecture may also need to provide for a similar approach when utilizing “P” pictures as a basis in the estimation of other “P” pictures and/or in the estimation of “B” pictures.

Current encoder architectures may be capable of addressing prediction dependencies, including the cross GOP boundary dependencies, that arise during the compression of the video sequence. However, in application spaces where the frame rate and/or the content in each frame is very large, the computational processing capacity of a video encoder, including processing capacity to perform encoding and reconstruction operations, may be limited. For example, a video encoder may not meet the demands in compression speed targets required for cable and satellite head ends or for Digital Video Disks (DVD) authoring/mastering systems. This may be of particular concern for the new Advanced Video Coding (AVC) or H.264 standard, where higher processing complexity may arise from the extension of prediction dependencies to a larger number of pictures, resulting in a possible slow down in the compression of the video sequence.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

Certain embodiments of the invention may be found in a method and system for high speed video processing using parallel encoders. Aspects of the method may comprise transferring a plurality of encoding groups into a plurality of parallel encoders. The parallel encoders may process intra-coded pictures in the encoding groups and may transfer the processed intra-coded pictures to a plurality of previous parallel encoders. The previous parallel encoders may generate a plurality of parallel outputs based on the transferred processed intra-coded pictures and the transferred encoding groups. The generated parallel outputs may be assembled into an encoded video output.

Aspects of the method may also comprise transferring consecutive encoding groups into consecutive parallel encoders, where at least one of the encoding groups may correspond to a GOP structure. An indication may be provided to a first parallel encoder that a first of the encoding groups is transferred to the first parallel encoder for processing. The intra-coded pictures may be encoded during processing in the parallel encoders and the transferred processed intra-coded pictures may be decoded in the previous parallel encoders before generating the parallel outputs. In another embodiment, the intra-coded pictures may be encoded and reconstructed during processing in the parallel encoders before transferring to the previous parallel encoders.

In another embodiment of the method, a GOP sequence may be delimited into encoding groups and transferring the encoding groups into parallel encoders. The parallel encoders may process last predictive pictures in the encoding groups and may transfer the processed last predictive pictures to a plurality of next parallel encoders. The next parallel encoders may generate parallel outputs based on the transferred processed last predictive pictures and the transferred encoding groups. The generated parallel outputs may be assembled into the encoded video output.

Aspects of the method may also comprise transferring consecutive encoding groups into consecutive parallel encoders, where at least one of the encoding groups may end in at least one bidirectional-predictive picture. The last predictive pictures may be encoded during processing in the parallel encoders and the transferred processed last predictive pictures may be decoded in the next parallel encoders before generating the parallel outputs. In another embodiment, the last predictive pictures may be encoded and reconstructed during processing in the parallel encoders before transferring to the next parallel encoders.

Aspects of the system may comprise a delimiter that transfers the encoding groups into the parallel encoders. The parallel encoders may process the intra-coded pictures and may transfer the intra-coded pictures to previous parallel encoders to generate the parallel outputs based on the transferred processed intra-coded pictures and the transferred encoding groups. An assembler may assemble the generated parallel outputs into the encoded video output.

The delimiter may delimit a GOP sequence so that at least one encoding group corresponds to a GOP structure. The delimiter may also transfer consecutive encoding groups into consecutive parallel encoders. A controller may indicate to a first parallel encoder that a first encoding group is transferred to the first parallel encoder for processing. The parallel encoders may encode the intra-coded pictures during processing and the previous parallel encoders may decode the transferred processed intra-coded pictures before generating the parallel outputs. In another embodiment, the parallel encoders may encode and reconstruct the intra-coded pictures during processing before transferring to the previous parallel encoders.

In another embodiment of the system, the delimiter may delimit the GOP sequence into a plurality of encoding groups so that at least one encoding group may end in at least one bidirectional-predictive picture. The delimiter may also transfer the encoding groups into the parallel encoders. The parallel encoders may process a plurality of last predictive pictures and may transfer the last predictive pictures to a plurality of next parallel encoders to generate the parallel outputs based on the transferred processed last predictive pictures and the transferred encoding groups. An assembler may assemble the generated parallel outputs into the encoded video output.

The delimiter may transfer consecutive encoding groups into consecutive parallel encoders. A controller may indicate to a first parallel encoder that a first encoding group is transferred to the first parallel encoder for processing. The parallel encoders may encode the last predictive pictures during processing and the next parallel encoders may decode the transferred processed last predictive pictures before generating the parallel outputs. In another embodiment, the parallel encoders may encode and reconstruct the last predictive pictures during processing before transferring to the next parallel encoders.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 illustrates an exemplary sequence of pictures to be encoded, indicating the location of GOP boundaries, picture coding types, and dependencies between picture coding types.

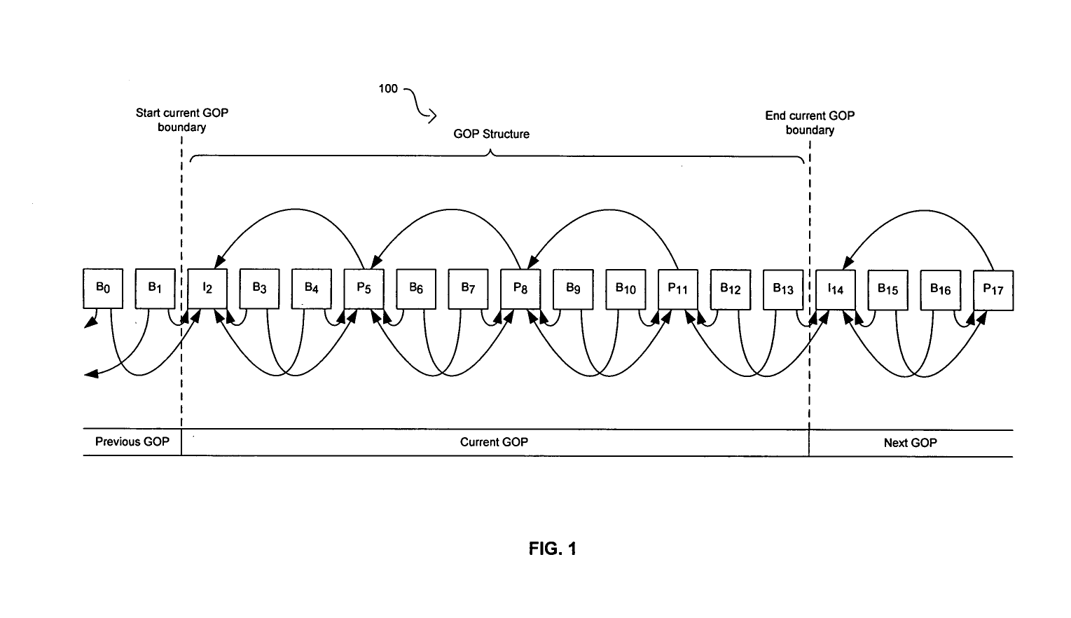

FIG. 2 is a block diagram of an exemplary encoder architecture with picture encoding and reconstruction capabilities, in connection with an embodiment of the invention.

FIG. 3 is a block diagram of an exemplary two-encoder parallel video encoding system, in accordance with an embodiment of the invention.

FIG. 4A illustrates an exemplary transfer of an “I” picture from a second parallel encoder to a first parallel encoder in a two-encoder parallel video encoding system, in accordance with an embodiment of the invention.

FIG. 4B illustrates an exemplary transfer of an “I” picture from a first parallel encoder to a second parallel encoder in a two-encoder parallel video encoding system, in accordance with an embodiment of the invention.

FIG. 5A illustrates an exemplary transfer of a “P” picture from a first parallel encoder to a second parallel encoder in a two-encoder parallel video encoding system, in accordance with an embodiment of the invention.

FIG. 5B illustrates an exemplary transfer of a “P” picture from a second parallel encoder to a first parallel encoder in a two-encoder parallel video encoding system, in accordance with an embodiment of the invention.

FIG. 6 is a block diagram of an exemplary multiple parallel encoder video encoding system, in accordance with an embodiment of the invention.

FIG. 7A illustrates an exemplary transfer of “I” pictures in a multiple parallel encoder video encoding system, in accordance with an embodiment of the invention.

FIG. 7B illustrates an exemplary transfer of “P” pictures in a multiple parallel encoder video encoding system, in accordance with an embodiment of the invention.

### DETAILED DESCRIPTION OF THE INVENTION

Certain embodiments of the invention may be found in a method and system for high speed video encoding using parallel encoders. A high speed encoding architecture may comprise a delimiter, a plurality of parallel encoders, an assembler, and a controller. The delimiter may break up a video sequence into encoding groups that are transferred to parallel encoders. The parallel encoders may process and transfer “I’ pictures in the encoding groups to previous parallel encoders or may process and transfer last “P” pictures in the encoding groups to next parallel encoders. The parallel encoders may then encode the transferred pictures and encoding groups to generate parallel outputs. The assembler may assemble an encoded video output from the parallel outputs based on timing information. The controller may be utilized to control the operation of the delimiter, the parallel encoders, and the assembler. This architectural approach may provide the compression speed targets necessary for high speed video encoding systems such as cable and satellite head ends, Digital Video Disks (DVD) authoring/mastering systems, and systems based on new encoding standards such as the H.264 standard.

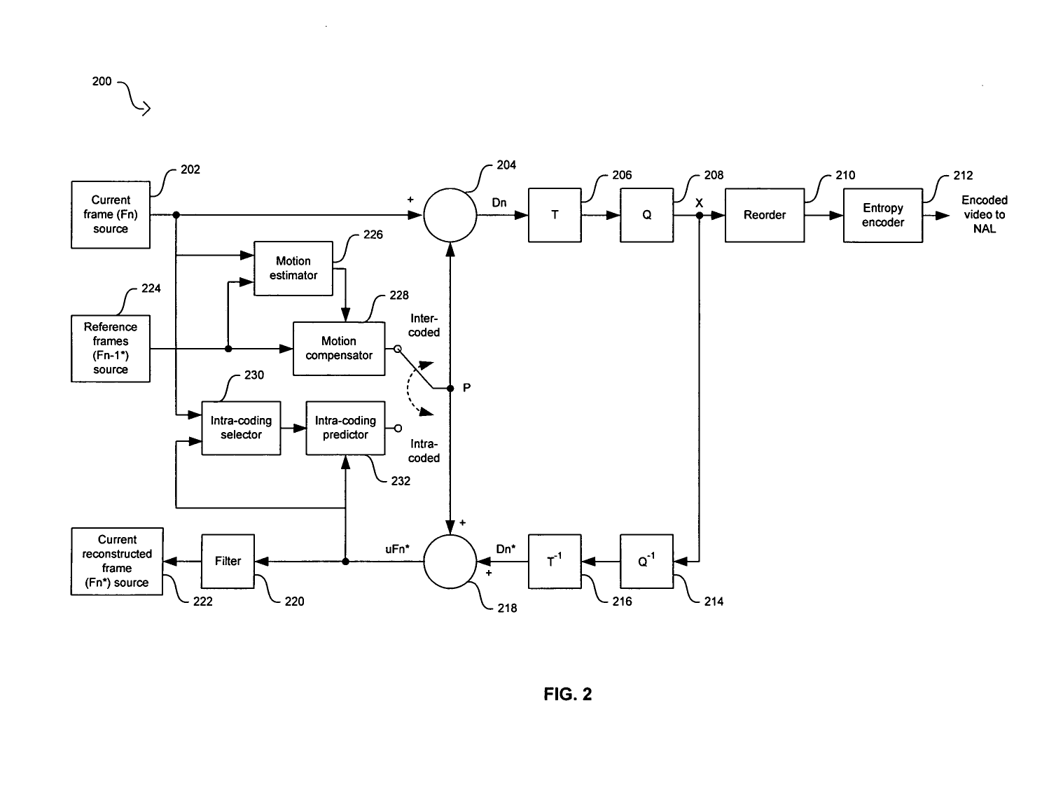

FIG. 2 is a block diagram of an exemplary encoder architecture with picture encoding and reconstruction capabilities, in connection with an embodiment of the invention. Referring to FIG. 2, a video encoder 200 may comprise a current frame (Fn) source 202, a first digital adder 204, a forward transform (T) 206, a forward quantizer (Q) 208, a reorder block 210, an entropy encoder 212, a reference frames (Fn−1*) source 224, a motion estimator 226, a motion compensator 228, an intra-coding selector 230, and an intra-coding predictor 232, a reverse quantizer (Q⁻¹) 214, a reverse transform (T⁻¹) 216, a second digital adder 218, a digital filter 220, and a current reconstructed frame (Fn*) source 222.

During the encoding operation, the current frame source 202 may provide a current frame or picture in a GOP for encoding. The current picture may be processed in units of a macroblock, where a macroblock corresponds to, for example, 16×16 pixels in the original image. Each macroblock may be encoded in intra-coded mode, for “I” pictures, or in inter-coded mode, for “P” and “B” pictures. In either mode, a prediction macroblock P may be formed on a reconstructed frame or picture. In intra-coded mode, the intra-coding selector 230 may select between sample images from a current picture Fn and from pictures which have been previously encoded, decoded, and reconstructed as shown by the unfiltered reconstructed output uFn* of the second digital adder 218. The intra-coding predictor 232 may generate the predicted macroblock P based on the unfiltered reconstructed output uFn* and the selection made by the intra-coding selector 230. In inter-coded mode, the predicted macroblock P may be generated based on the current picture and motion-compensated prediction from one or more reference frames in the reference frame source 224. The motion compensated prediction may be provided by the motion estimator 226 and the motion compensator 228. The motion compensated prediction may be based on at least one previous encoded and reconstructed picture in time and/or at least one subsequent encoded and reconstructed picture in time from the current picture being encoded.

The predicted macroblock P may be subtracted from the current macroblock by the first digital adder 204 to generate a difference macroblock Dn. The difference macroblock may be transformed by the forward transform 206 and quantized by the forward quantizer 208 to generate the quantized coefficients X. The quantized coefficients X may be reordered and entropy encoded by the reorder 210 and the entropy encoder 212 respectively before being passed to a Network Abstraction Layer (NAL). The entropy-encoded coefficients and any information necessary to decode the macroblock form the compressed bitstream.

During the reconstruction operation, the quantized coefficients X may be re-scaled and inverse transformed by the reverse quantizer 214 and the inverse transform 216 to generate a reconstructed difference macroblock Dn*. The prediction macroblock P may be added to the reconstructed difference macroblock Dn* by the second digital adder 218 to generate the unfiltered reconstructed output uFn*. The filter 220 may be applied to uFn* to reduce the effects of blocking distortion and a reconstructed reference frame or picture may be generated Fn*.

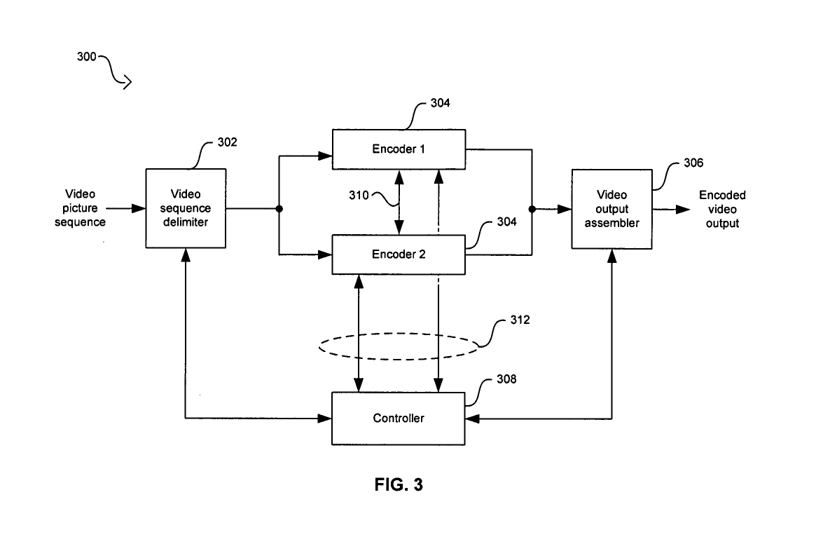

FIG. 3 is a block diagram of an exemplary two-encoder parallel video encoding system, in accordance with an embodiment of the invention. Referring to FIG. 3, the two-encoder parallel video encoding system 300 may comprise a video sequence delimiter 302, a first parallel encoder 304 labeled encoder 1, a second parallel encoder 304 labeled encoder 2, a video output assembler 306, a controller 308, a data transfer bus 310, and a plurality of control signals 312. The video sequence delimiter 302 may comprise suitable logic, circuitry and/or code that may be adapted to delimit a video picture sequence into a plurality of encoding groups and to transfer the encoding groups to encoder 1 and encoder 2 in accordance to an encoding group transfer schedule. The encoding groups may be delimited to have the same group structure as a GOP structure utilized in the video picture sequence or to have a different group structure than the GOP structure. The encoding group transfer schedule may require that, for example, the video sequence delimiter 302 transfer a first encoding group to encoder 1 or to encoder 2 and then alternate the transfer of the following encoding groups between encoder 1 and encoder 2 based on whether the first encoding group was transferred to encoder 1 or to encoder 2. The video sequence delimiter 302 may indicate to the controller 308 when at least one encoding group is ready for transfer and/or when at least one encoding group has been transferred to a parallel encoder in the two-encoder parallel video encoding system 300. An example of a parallel encoder 304 may be, but need not be limited to, the video encoder 200 in FIG. 2.

The parallel encoder 304 may comprise suitable logic, circuitry and/or code that may be adapted to perform the encoding, decoding, and reconstruction of intra-coded, predictive, and bidirectional-predictive pictures in an encoding group. The parallel encoder 304 may also be adapted to transfer encoded and/or reconstructed pictures to another parallel encoder 304 via the data transfer bus 310. For example, the encoder 1 in the two-encoder parallel video encoding system 300 may transfer encoded and/or reconstructed pictures to encoder 2 for processing with the encoding group transferred to encoder 2 by the video sequence delimiter 302. Similarly, encoder 2 may transfer encoded and/or reconstructed pictures to encoder 1 for processing with the encoding group transferred to encoder 1 by the video sequence delimiter 302. The parallel encoder 304 may also comprise suitable logic, circuitry and/or code that may be adapted to store encoded and/or reconstructed pictures for transferring to another encoder and/or to transfer to the video output assembler 306.

The choice to transfer encoded or reconstructed pictures between parallel encoders may be based on whether there exist bandwidth limitations in the data transfer bus 310, in which case transferring encoded pictures may be preferable, or whether there are processing limitations, in which case transferring of reconstructed pictures may be preferable. The parallel encoder 304 may generate a parallel output that may be transferred to the video output assembler 306. In this regard, there may be a parallel output that corresponds to encoder 1 and a parallel output that corresponds to encoder 2. The parallel output from a parallel encoder 304 may comprise at least a portion of an encoding group or at least a portion of a plurality of encoding groups. The parallel output from a parallel encoder 304 may also comprise additional information related to the encoding groups, for example, timing and/or position information for the video output assembler 306 to assemble the encoded video output. The encoder 1 and the encoder 2 may indicate to the controller 308 via the plurality of control signals 312 that at least a portion of an encoding group is ready for transfer or has been transferred to the video output assembler 306.

The video output assembler 306 may comprise suitable logic, circuitry and/or code that may be adapted to assemble the parallel outputs from encoder 1 and encoder 2 into the encoded video stream. The video output assembler 306 may order the encoded pictures from the parallel outputs according to their original order in the video picture sequence. In this regard, the video output assembler 306 may utilize timing and/or ordering information provided by the parallel outputs and/or additional timing and/or ordering information provided by the controller 308.

The controller 308 may comprise suitable logic, circuitry and/or code that may be adapted to control the delimiting and transfer, the processing, and the assembling of encoding groups by the video sequence delimiter 302, the encoder 1 and the encoder 2, and the video output assembler 306 respectively. The controller 308 may control the transfer and processing of encoding groups in the encoder 1 and the encoder 2 via the plurality of control signals 312.

During operation, the encoder 1 and the encoder 2 in FIG. 3 may generate a plurality of statistics regarding the GOPs being processed. This statistical information may comprise, for example, complexity metrics and/or the number of bits used to encode a picture and may be generated on a picture-by-picture basis and/or on a GOP-by-GOP basis. Moreover, the statistical information may be generated based on more than one GOP encoding. In this regard, the encoder 1 and the encoder 2 may transfer this statistical information to the controller 308. The controller 308 may then utilize this statistical information to determine a rate control that may then be signaled and/or communicated back to the parallel encoders. The rate control may be implemented by adjusting the quantization parameters in order to produce an encoded video output where the bitrate of at least a portion of the encoded video output falls within a determined set of limits. While each parallel encoder may comprise a rate control device and/or mechanism for controlling its own bitrate, in the case of high-speed parallel encoding operations, the controller 308 may be better suited to determine the rate control parameters of at least one of the parallel encoders since it may have access to statistical information from encoding of the entire video picture sequence.

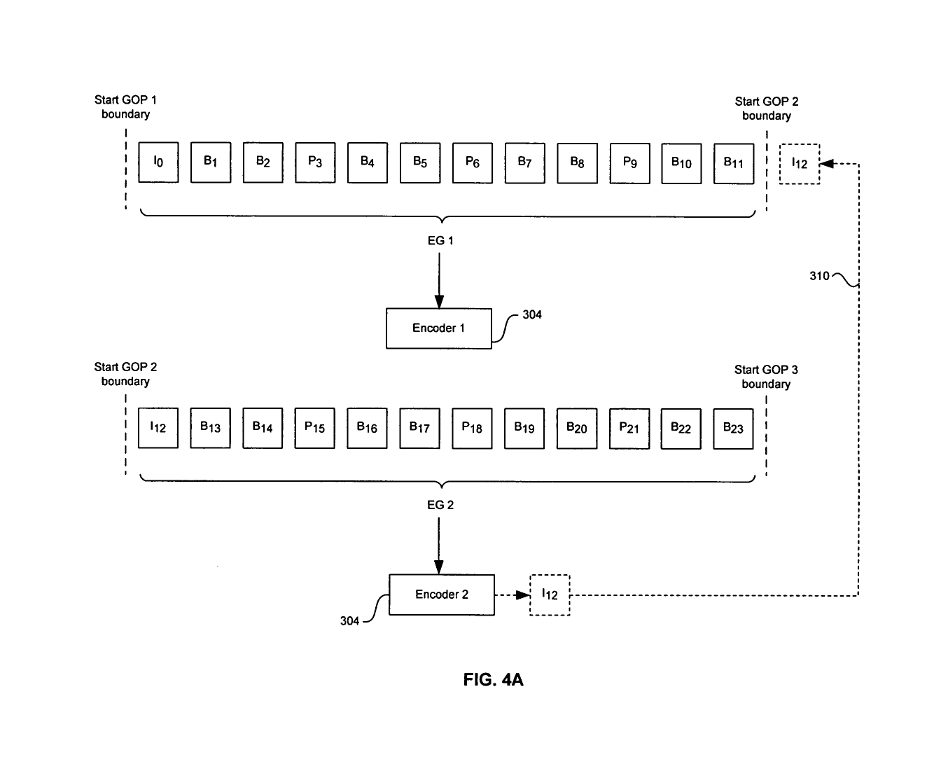

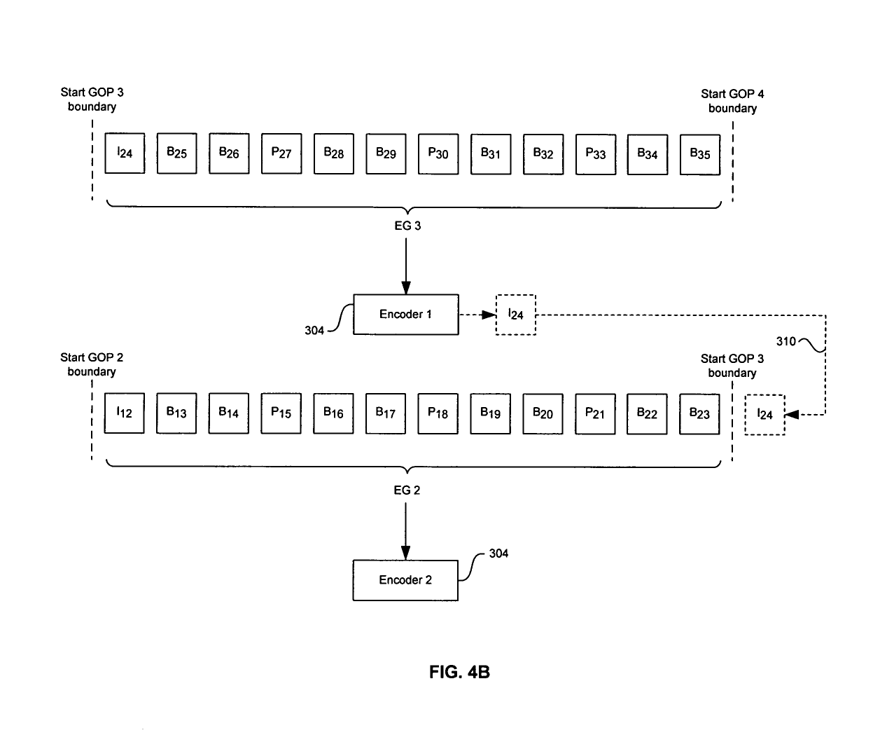

FIG. 4A illustrates an exemplary transfer of an “I” picture from a second parallel encoder to a first parallel encoder in a two-encoder parallel video encoding system, in accordance with an embodiment of the invention. Referring to FIG. 4A, the first parallel encoder 304 labeled encoder 1 in FIG. 3 may process a first encoding group EG 1, where the first encoding group EG 1 may correspond in structure to a first GOP in a video picture sequence. The first encoding group EG 1 may comprise pictures I₀, B₁, B₂, P₃, B₄, B₅, P₆, B₇, B₈, P₉, B₁₀, and B₁₁. The second parallel encoder 304 labeled encoder 2 in FIG. 3 may process a second encoding group EG 2, where the second encoding group EG 2 may correspond to a second GOP in the GOP video picture sequence. The second encoding group EG 2 may comprise pictures I₁₂, B₁₃, B₁₄, P₁₅, B₁₆, B₁₇, P₁₈, B₁₉, B₂₀, P₂₁, B₂₂, and B₂₃. The first encoding group EG 1 and the second encoding group EG 2 may have been delimited by the video sequence delimiter 302 in FIG. 3 to correspond to the first GOP and the second GOP respectively.

In operation, the encoder 2 may encode picture I₁₂ and may transfer the encoded picture I₁₂ to the encoder 1 via the data transfer bus 310 to be utilized as a basis for estimating and encoding the pictures B₁₀ and B₁₁ of the first encoding group EG 1. The encoder 1 may then decode and reconstruct the encoded picture I₁₂ before estimating and encoding pictures B₁₀ and B₁₁. In another embodiment, the encoder 2 may encode, decode and reconstruct picture I₁₂ and may transfer the reconstructed picture I₁₂ to the encoder 1 via the data transfer bus 310 to be utilized as a basis for estimating and encoding the pictures B₁₀ and B₁, of the first encoding group EG 1.

The controller 308 may control the timing of the transfer of an “I” picture from encoder 2 to encoder 1 and may determine whether the “I” picture transferred is to be an encoded picture or a reconstructed picture. A start-up transient may occur because of the time required to buffer the encoding groups into the parallel encoders before starting the parallel encoding process. Moreover, the transfer of picture I₁₂ from encoder 2 to encoder 1 may occur at any time in the processing of the first encoding group EG 1 by encoder 1. For example, picture I₁₂ may be transferred as soon as encoder 2 completes processing picture I₁₂. The encoder 1 may then buffer the processed picture I₁₂ until pictures B₁₀ and B₁₁ are to be processed. In another example, picture I₁₂ may be transferred by encoder 2 to encoder 1 at some point after encoder 1 completes processing pictures I₀, P₃, P₆, and P₉ and is ready to process the bidirectional-predictive pictures in the first encoding group EG 1. Similar approaches may be followed when the encoding groups differ in structure from those shown in FIG. 4A.

FIG. 4B illustrates an exemplary transfer of an “I” picture from a first parallel encoder to a second parallel encoder in a two-encoder parallel video encoding system, in accordance with an embodiment of the invention. Referring to FIG. 4B, once the encoder 1 completes processing the first encoding group EG 1, it may process a third encoding group EG 3, where the third encoding group EG 3 may correspond to a third GOP in the video picture sequence. The third encoding group EG 3 may comprise pictures I₂₄, B₂₅, B₂₆, P₂₇, B₂₈, B₂₉, P₃₀, B₃₁, B₃₂, P₃₃, B₃₄, and B₃₅ and may have been delimited by the video sequence delimiter 302 in FIG. 3 to correspond to the third GOP in the video picture sequence.

In operation, the encoder 1 may encode picture I₂₄ from the third encoding group EG 3 and may transfer the encoded picture I₂₄ to the encoder 2 via the data transfer bus 310 to be utilized as a basis for estimating and encoding the pictures B₂₂ and B₂₃ of the second encoding group EG 2. The encoder 2 may then decode and reconstruct the encoded picture I₂₄ before estimating and encoding pictures B₂₂ and B₂₃. In another embodiment of the invention, the encoder 1 may encode, decode and reconstruct picture I₂₄ and may transfer the reconstructed picture I₂₄ to the encoder 2 via the data transfer bus 310 to be utilized as a basis for estimating and encoding the pictures B₂₂ and B₂₃ of the second encoding group EG 2.

The controller 308 may control the transfer of an “I” picture from encoder 1 to encoder 2 and may determine whether the “I” picture transferred is to be an encoded picture or a reconstructed picture. The transfer of an “I” picture from encoder 1 to encoder 2 may occur at any time during the processing of the second encoding group EG 2 by the encoder 2.

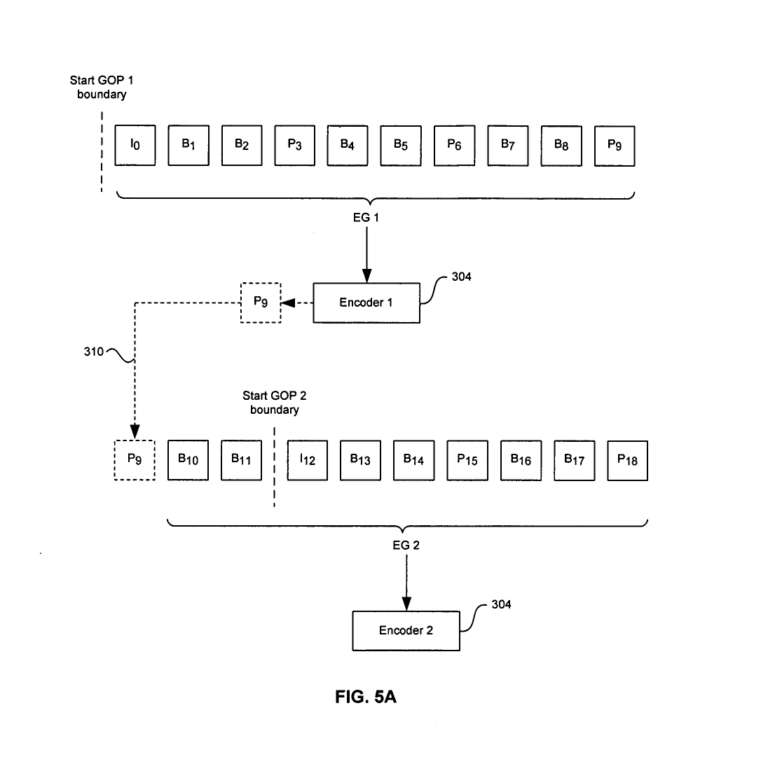

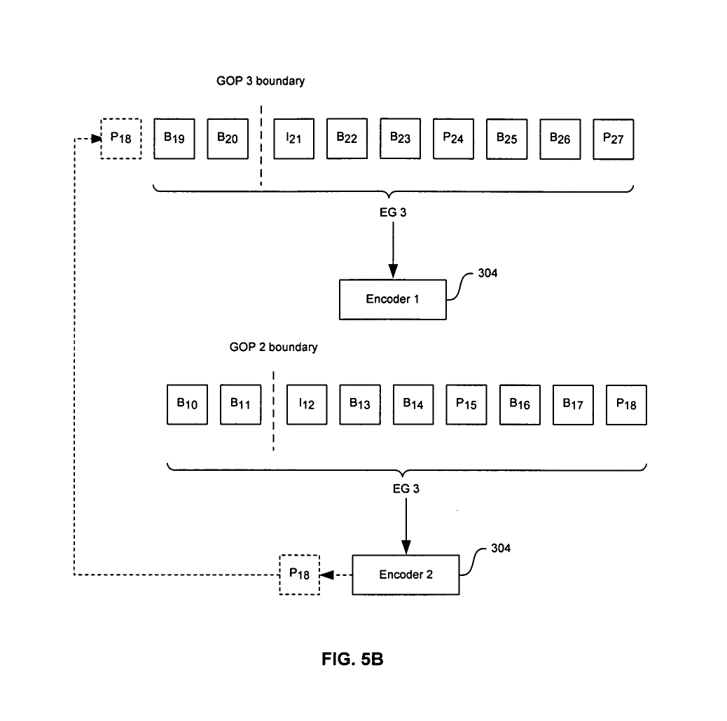

FIG. 5A illustrates an exemplary transfer of a “P” picture from a first parallel encoder to a second parallel encoder in a two-encoder parallel video encoding system, in accordance with an embodiment of the invention. Referring to FIG. 5A, the first parallel encoder 304 labeled encoder 1 in FIG. 3 may process a first encoding group EG 1, where the first encoding group EG 1 may comprise a portion of a first GOP in a video picture sequence. The first encoding group EG 1 may comprise from the first picture in the GOP structure until the last “P” picture in the GOP structure, that is, the first encoding group EG 1 may comprise pictures I₀, B₁, B₂, P₃, B₄, B₅, P₆, B₇, B₈, and P₉ from the first GOP in the video picture sequence. The second parallel encoder 304 labeled encoder 2 in FIG. 3 may process a second encoding group EG 2, where the second encoding group EG 2 may comprise a portion of the first GOP and a portion of a second GOP in the GOP video picture sequence. The second encoding group EG 2 may comprise pictures B₁₀, B₁₁, I₁₂, B₁₃, B₁₄, P₁₅, B₁₆, B₁₇, and P₁₈. The first encoding group EG 1 and the second encoding group EG 2 may have been delimited by the video sequence delimiter 302 in FIG. 3 to comprise the pictures describe above.

In operation, the encoder 1 may encode picture P₉ and may transfer the encoded picture P₉ to the encoder 2 via the data transfer bus 310 to be utilized as a basis for estimating and encoding the pictures B₁₀ and B₁, of the second encoding group EG 2. The encoder 2 may then decode and reconstruct the encoded picture P₉ before estimating and encoding pictures B₁₀ and B₁₁. In another embodiment, the encoder 1 may encode, decode and reconstruct picture P₉ and may transfer the reconstructed picture P₉ to the encoder 2 via the data transfer bus 310 to be utilized as a basis for estimating and encoding the pictures B₁₀ and B₁₁ of the second encoding group EG 2.

The controller 308 may control the timing of the transfer of a “P” picture from encoder 1 to encoder 2 and may determine whether the “P” picture transferred is to be an encoded picture or a reconstructed picture. A start-up transient may occur because of the time required to buffer the encoding groups into the parallel encoders before starting the parallel encoding process. Moreover, the transfer of picture P₉ from encoder 1 to encoder 2 may occur at any time in the processing of the second encoding group EG 2 by encoder 2. For example, picture P₉ may be transferred as soon as encoder 1 completes processing picture P₉. The encoder 2 may then buffer the processed picture P₉ until pictures B₁₀ and B₁₁ are to be processed. In another example, picture P₉ may be transferred by encoder 1 to encoder 2 at some point after encoder 2 completes processing pictures I₁₂, P₁₅, and P₁₈ and is ready to process the bidirectional-predictive pictures in the second encoding group EG 2. Similar approaches may be followed when the encoding groups differ in structure from those shown in FIG. 5A.

FIG. 5B illustrates an exemplary transfer of a “P” picture from a second parallel encoder to a first parallel encoder in a two-encoder parallel video encoding system, in accordance with an embodiment of the invention. Referring to FIG. 5B, once the encoder 1 completes processing the first encoding group EG 1, it may process a third encoding group EG 3, where the third encoding group EG 3 comprises a portion of the second GOP and a portion of a third GOP in the GOP video picture sequence. The third encoding group EG 3 may comprise pictures B₁₉, B₂₀, I₂₁, B₂₂, B₂₃, P₂₄, B₂₅, B₂₆, and P₂₇ and may have been delimited by the video sequence delimiter 302 in FIG. 3

In operation, the encoder 2 may encode picture P₁₈ from the third encoding group EG 3 and may transfer the encoded picture P₁₈ to the encoder 1 via the data transfer bus 310 to be utilized as a basis for estimating and encoding the pictures B₁₉ and B₂₀ of the third encoding group EG 3. The encoder 1 may then decode and reconstruct the encoded picture P₁₈ before estimating and encoding pictures B₁₉ and B₂₀. In another embodiment, the encoder 2 may encode, decode and reconstruct picture P₁₈ and may transfer the reconstructed picture P₁₈ to the encoder 1 via the data transfer bus 310 to be utilized as a basis for estimating and encoding the pictures B₁₉ and B₂₀ of the third encoding group EG 3.

The controller 308 may control the transfer of a “P” picture from encoder 2 to encoder 1 and may determine whether the “P” picture transferred is to be an encoded picture or a reconstructed picture. The transfer of a “P” picture from encoder 2 to encoder 1 may occur at any time during the processing of the third encoding group EG 2 by encoder 1.

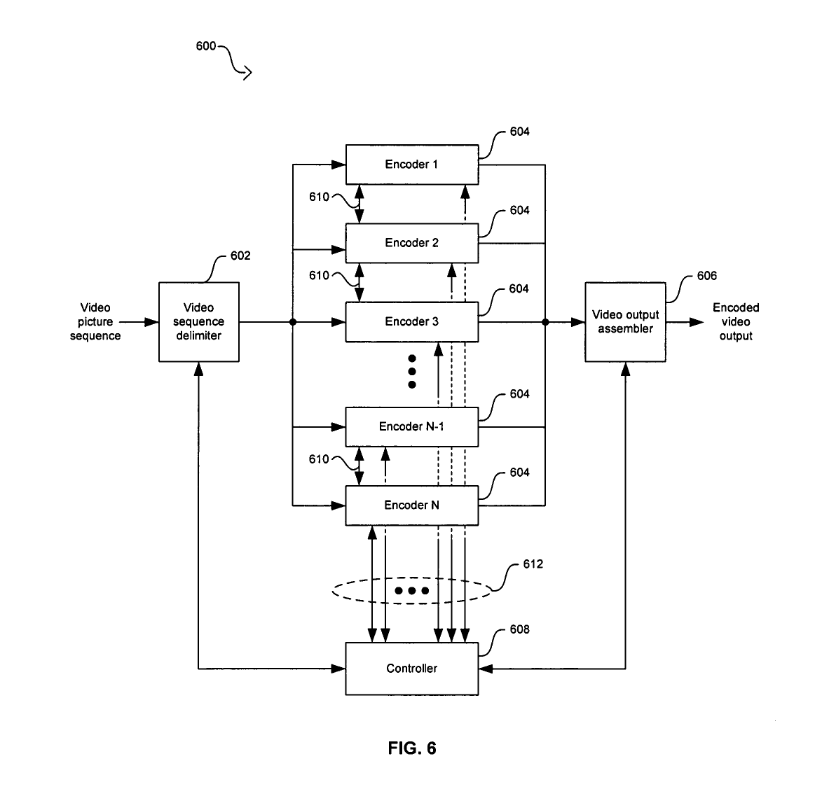

FIG. 6 is a block diagram of an exemplary multiple parallel encoder video encoding system, in accordance with an embodiment of the invention. Referring to FIG. 6, the multiple parallel encoder video encoding system 600 may comprise a video sequence delimiter 602, a plurality of parallel encoders 604, a video output assembler 606, a controller 608, a plurality of data transfer buses 610, and a plurality of control signals 612. The video sequence delimiter 602 may comprise suitable logic, circuitry and/or code that may be adapted to delimit a video picture sequence into a plurality of encoding groups. The encoding groups may be delimited to have the same group structure as a GOP structure utilized in the video picture sequence or to have a different group structure than the GOP structure.

The video sequence delimiter 602 may also be adapted to transfer the encoding groups to the plurality of parallel encoders 604 in accordance to an encoding group transfer schedule. The encoding group transfer schedule may require that the video sequence delimiter 602 transfer a first encoding group to a first parallel encoder 604, where the first parallel encoder 604 may be, for example, the parallel encoder labeled encoder 1. Then, a second encoding group, which may be consecutive in time to the first encoding group, may be transferred to a consecutive parallel encoder to encoder 1, for example, the parallel encoder labeled encoder 2. Similarly, a third encoding group, which may be consecutive in time to the second encoding group, may be transferred to a consecutive parallel encoder to encoder 2, for example, the parallel encoder labeled encoder 3. A similar approach may be followed until the first N consecutive encoding groups are transferred to the N parallel encoders 604 in the system. Encoding groups transferred after the first N consecutive encoding groups may follow a similar transfer scheme to that utilized for the first N consecutive encoding groups.

The video sequence delimiter 602 may indicate to the controller 608 when at least one encoding group is ready for transfer and/or when at least one encoding group has been transferred to a parallel encoder in the multiple parallel encoder video encoding system 600.

The parallel encoder 604 may comprise suitable logic, circuitry and/or code that may be adapted to perform the encoding, decoding, and reconstruction of intra-coded, predictive, and bidirectional-predictive pictures in an encoding group. The parallel encoder 604 may also be adapted to transfer encoded and/or reconstructed pictures to a consecutive parallel encoder via the data transfer bus 610. In this regard, a consecutive parallel encoder may refer to a parallel encoder in the multiple parallel encoder video encoding system 600 that is processing an encoding group that is consecutive in time to the encoding group that is being processed by the parallel encoder 604. The parallel encoder 604 may also comprise suitable logic, circuitry and/or code that may be adapted to store encoded and/or reconstructed pictures for transferring to a consecutive parallel encoder and/or to transfer to the video output assembler 606.

The choice to transfer encoded or reconstructed pictures between consecutive parallel encoders may be based on whether there exist bandwidth limitations in the data transfer bus 610, in which case transferring encoded pictures may be preferable, or whether there are processing limitations, in which case transferring of reconstructed pictures may be preferable. The parallel encoder 604 may generate a parallel output that may be transferred to the video output assembler 606. In this regard, there may be a parallel output that corresponds to each of the plurality of parallel encoders 604. The parallel output from a parallel encoder 604 may comprise at least a portion of an encoding group or at least a portion of a plurality of encoding groups. The parallel output from a parallel encoder 604 may also comprise additional information related to the encoding groups, for example, timing and/or position information for the video output assembler 606 to assemble the encoded video output. The plurality of parallel encoders 604 may indicate to the controller 608 via the plurality of control signals 612 that at least a portion of an encoding group is ready for transfer or has been transferred to the video output assembler 606.

The video output assembler 606 may comprise suitable logic, circuitry and/or code that may be adapted to assemble the parallel outputs from the plurality of parallel encoders 604 into the encoded video stream. The video output assembler 606 may order the encoded pictures from the parallel outputs according to their original order in the video picture sequence. In this regard, the video output assembler 606 may utilize timing and/or ordering information provided by the parallel outputs and/or additional timing and/or ordering information provided by the controller 608.

The controller 608 may comprise suitable logic, circuitry and/or code that may be adapted to control the delimiting and transfer, the processing, and the assembling of encoding groups by the video sequence delimiter 602, the plurality of parallel encoders 604, and the video output assembler 306 respectively. The controller 608 may control the transfer and processing of encoding groups in the plurality of parallel encoders 604 via the plurality of control signals 312.

During operation, the plurality of parallel encoders 604 in FIG. 6 may generate a plurality of statistics regarding the GOPs being processed. This statistical information may be generated on a GOP-by-GOP basis and/or may be generated based on more than one GOP encoding. In this regard, the plurality of parallel encoders 604 may transfer this statistical information to the controller 608 and the controller 608 may utilize this statistical information to determine rate control parameters that may then be transferred back to the parallel encoders. Rate control parameters may be utilized to control the encoding parameters, for example, transform and/or quantization parameters, in order to produce an encoded video output where the bitrate of at least a portion of the encoded video output falls within a determined set of limits. While each parallel encoder may comprise a rate control device and/or mechanism for controlling its own bitrate, in the case of high-speed parallel encoding operations, the controller 608 may be better suited to determine the rate control parameters of at least one of the parallel encoders since it may have access to statistical information from encoding of the entire video picture sequence.

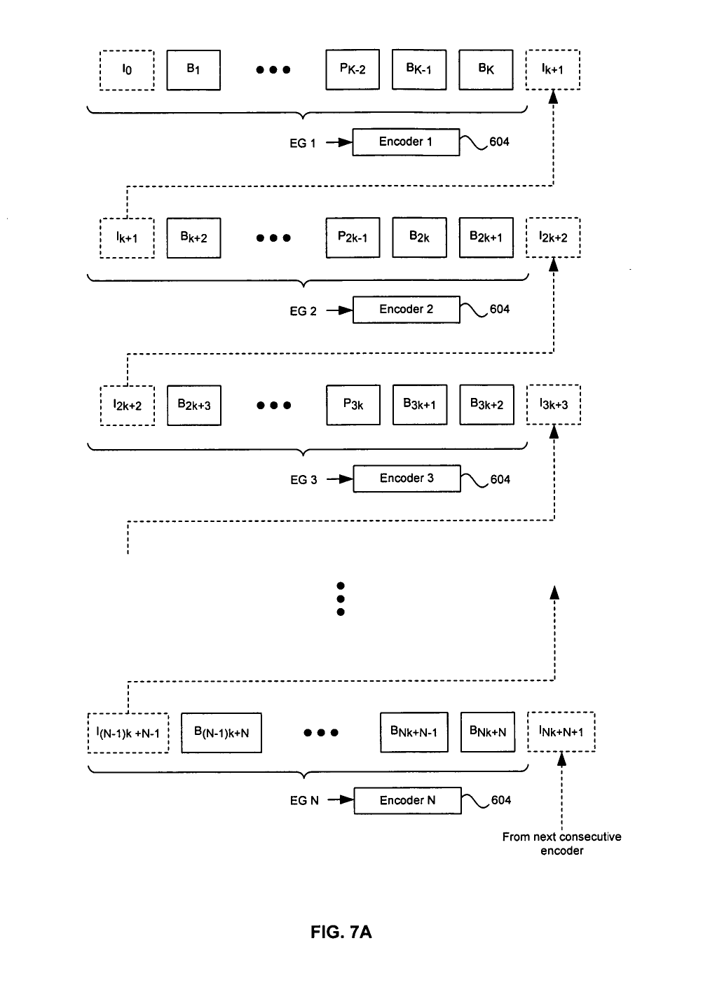

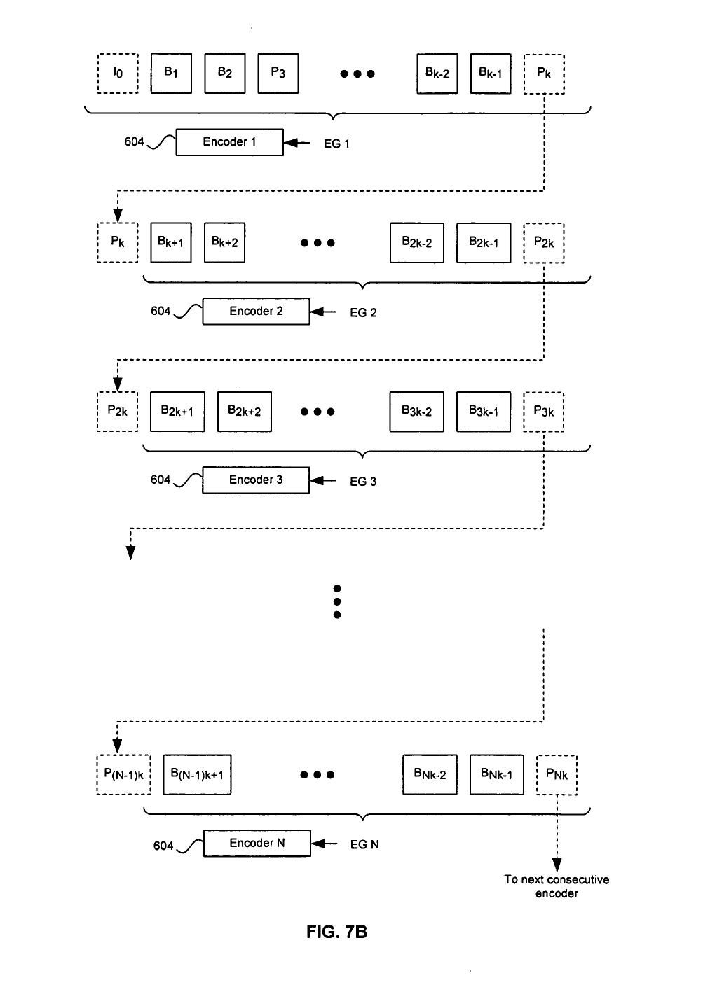

FIG. 7A illustrates an exemplary transfer of “I” pictures in a multiple parallel encoder video encoding system, in accordance with an embodiment of the invention. Referring to FIG. 7A, the first parallel encoder 604 labeled encoder 1 in FIG. 6 may process a first encoding group EG 1, where the first encoding group EG 1 may correspond in structure to a first GOP in a video picture sequence. The first encoding group EG 1 may comprise pictures I₀, B₁, B₂, . . . , Pₖ₋₂, Bₖ₋₁, and Bₖ, where k+1 is the length of the encoding groups. The second parallel encoder 604 labeled encoder 2 in FIG. 6 may process a second encoding group EG 2, where the second encoding group EG 2 may correspond to a second GOP in the GOP video picture sequence. The second encoding group EG 2 may comprise pictures I_{K+1}, B_{K+2}, . . . , P₂ₖ₋₁, B₂ₖ, and B₂ₖ₊₁. Similarly, encoder 3 through encoder N may process encoding groups EG 3 through EG N in FIG. 7A respectively. In this regard, encoding group EG 1 through EG N may be consecutive encoding groups and encoder 1 through encoder N may be consecutive parallel encoders.

In operation, the encoder 2 may encode an intra-coded picture Iₖ₊₁ and may transfer the encoded picture Iₖ₊1 to the encoder 1 via the data transfer bus 610 to be utilized as a basis for estimating and encoding the bidirectional-predictive pictures Bₖ₋₁ and Bₖ of the first encoding group EG 1. In this regard, the encoder 1 may correspond to a previous parallel encoder relative to the encoder 2. The encoder 1 may then decode and reconstruct the encoded picture Iₖ₊₁ before estimating and encoding pictures Bₖ₋₁ and Bₖ. Similarly, the encoder 3 may encode the intra-coded picture I₂ₖ₊₂ and may transfer the encoded picture I₂ₖ₊₂ to the encoder 2 via the data transfer bus 610 to be utilized as a basis for estimating and encoding the bidirectional-predictive pictures B₂ₖ and B₂ₖ₊₁ of the second encoding group EG 2. In this regard, the encoder 2 may correspond to a previous parallel encoder relative to the encoder 3. A similar operation to the one described for encoder 1, encoder 2, and encoder 3 may be carried out through encoder N. Encoding groups transferred after the first N consecutive encoding groups may follow a similar processing scheme to that utilized for the first N consecutive encoding groups.

In another embodiment, the encoder 2 may encode, decode and reconstruct picture Iₖ₊₁ and may transfer the reconstructed picture Iₖ₊₁ to the encoder 1 via the data transfer bus 610 to be utilized as a basis for estimating and encoding the pictures Bₖ₋₁ and Bₖ of the first encoding group EG 1. Similarly, the encoder 3 may encode, decode and reconstruct picture I₂ₖ₊ₖ and may transfer the reconstructed picture I₂ₖ₊ₖ to the encoder 1 via the data transfer bus 610 to be utilized as a basis for estimating and encoding the pictures B₂ₖ and B₂ₖ₊₁ of the second encoding group EG 2. A similar operation to the one described for encoder 1, encoder 2, and encoder 3 may be carried out through encoder N. Encoding groups transferred after the first N consecutive encoding groups may follow a similar processing scheme to that utilized for the first N consecutive encoding groups.

The controller 608 may control the timing of the transfer of an “I” picture from a parallel encoder to a previous parallel encoder and may determine whether the “I” picture transferred is to be an encoded picture or a reconstructed picture. A start-up transient may occur because of the time required to buffer the encoding groups into the parallel encoders before starting the parallel encoding process; in this case, for example, the start-up transient may be proportional to the number of parallel encoders 604 in the multiple parallel encoder video encoding system 600. Moreover, the transfer of an “I” picture from a parallel encoder to a previous parallel encoder may occur at any time in the processing of the encoding group by the previous parallel encoder. For example, picture Iₖ₊₁ may be transferred to encoder 1 as soon as encoder 2 completes processing picture Iₖ₊₁. The encoder 1 may then buffer the processed picture Iₖ₊₁ until pictures Bₖ₋₁ and Bₖ are to be processed. In another example, picture Iₖ₊₁ may be transferred to encoder 1 at some point after encoder 1 completes processing pictures the “I” and “P” pictures in the first encoding group EG 1 and is ready to process the bidirectional-predictive pictures in the first encoding group EG 1. Similar approaches may be followed when the encoding groups differ in structure from those shown in FIG. 7A.

FIG. 7B illustrates an exemplary transfer of “P” pictures in a multiple parallel encoder video encoding system, in accordance with an embodiment of the invention. Referring to FIG. 7B, the first parallel encoder 604 labeled encoder 1 in FIG. 6 may process a first encoding group EG 1. The first encoding group EG 1 may comprise pictures I₀, B₁, B₂, . . . , Bₖ₋₂, Bₖ₋₁, and Pₖ, where k+1 is the length of the first encoding group. The second parallel encoder 604 labeled encoder 2 in FIG. 6 may process a second encoding group EG 2. The second encoding group EG 2 may comprise pictures B_{K+1}, B_{K+2}, . . . , B₂ₖ₋₂, B₂ₖ₋₁, and P₂ₖ, where the length of the second encoding group and of subsequent encoding groups is k. Similarly, encoding groups EG 3 through EG N in FIG. 7B may be processed by encoder 3 through encoder N respectively. In this regard, encoding group EG 1 through EG N may be consecutive encoding groups and encoder 1 through encoder N may be consecutive parallel encoders.

In operation, the encoder 1 may encode a predictive picture Pₖ and may transfer the encoded picture Pₖ to the encoder 2 via the data transfer bus 610 to be utilized as a basis for estimating and encoding the bidirectional-predictive pictures Bₖ₊₁ and Bₖ₊₂ of the second encoding group EG 2. In this regard, the encoder 2 may correspond to a next parallel encoder relative to the encoder 1. The encoder 2 may then decode and reconstruct the encoded picture Pₖ before estimating and encoding pictures Bₖ₊₁ and Bₖ₊₂. Similarly, the encoder 2 may encode the intra-coded picture P₂ₖ and may transfer the encoded picture P₂ₖ to the encoder 3 via the data transfer bus 610 to be utilized as a basis for estimating and encoding the bidirectional-predictive pictures B₂ₖ₊₁ and B₂ₖ₊₂ of the third encoding group EG 3. In this regard, the encoder 3 may correspond to a next parallel encoder relative to the encoder 2. A similar operation to the one described for encoder 1, encoder 2, and encoder 3 may be carried out through encoder N. Encoding groups transferred after the first N consecutive encoding groups may follow a similar processing scheme to that utilized for the first N consecutive encoding groups.

In another embodiment, the encoder 1 may encode, decode and reconstruct picture Pₖ and may transfer the reconstructed picture Pₖ to the encoder 2 via the data transfer bus 610 to be utilized as a basis for estimating and encoding the pictures Bₖ₊₁ and Bₖ₊₂ of the second encoding group EG 2. Similarly, the encoder 2 may encode, decode and reconstruct picture P₂ₖ and may transfer the reconstructed picture P₂ₖ to the encoder 3 via the data transfer bus 610 to be utilized as a basis for estimating and encoding the pictures B₂ₖ₊₁ and B₂ₖ₊₂ of the third encoding group EG 3. A similar operation to the one described for encoder 1, encoder 2, and encoder 3 may be carried out through encoder N. Encoding groups transferred after the first N consecutive encoding groups may follow a similar processing scheme to that utilized for the first N consecutive encoding groups.

The controller 608 may control the timing of the transfer of a “P” picture from a parallel encoder to a next parallel encoder and may determine whether the “P” picture transferred is to be an encoded picture or a reconstructed picture. A start-up transient may occur because of the time required to buffer the encoding groups into the parallel encoders before starting the parallel encoding process; in this case, for example, the start-up transient may be proportional to the number of parallel encoders 604 in the multiple parallel encoder video encoding system 600. Moreover, the transfer of a “P” picture from a parallel encoder to a next parallel encoder may occur at any time in the processing of the encoding group by the next parallel encoder. For example, picture Pk may be transferred to encoder 2 as soon as encoder 1 completes processing picture Pₖ. The encoder 1 may then buffer the processed picture Pₖ until pictures Bₖ₊₁ and Bₖ₊₂ are to be processed. In another example, picture Pₖ may be transferred to encoder 2 at some point after encoder 2 completes processing pictures the “I” and “P” pictures in the second encoding group EG 2 and is ready to process the bidirectional-predictive pictures in the second encoding group EG 2. Similar approaches may be followed when the encoding groups differ in structure from those shown in FIG. 7B.

The high-speed parallel encoding approach described in FIGS. 3-7B may not be limited to a GOP structure in each parallel encoder. In this regard, a parallel encoder may be adapted to process at least one GOP structure. For example, referring to FIG. 3, the first parallel encoder 304 labeled encoder 1 may process or encode a first GOP or GOP1 and a second GOP or GOP2 while the second parallel encoder 304 may process or encode a third GOP or GOP3 and a fourth GOP or GOP4. Similarly, referring to FIG. 6, a first of the plurality of parallel encoders 604 may process or encode a first GOP or GOP1 and a second GOP or GOP2 while subsequent parallel encoders in the plurality of parallel encoders 604 may also process at least one GOP.

The parallel encoding approach described herein may provide the necessary computational resources to achieve compression speed targets in high speed video encoding systems such as cable and satellite head ends, Digital Video Disks (DVD) authoring/mastering systems, and systems based on new encoding standards such as the AVC or H.264 standard.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for video compression, the method comprising:
transferring a plurality of encoding groups into a plurality of parallel encoders;
processing in said plurality of parallel encoders a plurality of intra-coded pictures in said plurality of encoding groups;
transferring said processed plurality of intra-coded pictures to a plurality of previous parallel encoders;
generating a plurality of parallel outputs based on said transferred processed plurality of intra-coded pictures and said transferred plurality of encoding groups; and
assembling said generated plurality of parallel outputs into an encoded video output.

2. The method according to claim 1, wherein at least one encoding group in said plurality of encoding groups corresponds to a GOP structure.

3. The method according to claim 1, further comprising transferring consecutive encoding groups in said plurality of encoding groups into consecutive parallel encoders in said plurality of parallel encoders.

4. The method according to claim 1, further comprising indicating to a first parallel encoder in said plurality of parallel encoders that a first of said plurality of encoding groups is transferred to said first parallel encoder for processing.

5. The method according to claim 1, further comprising encoding said plurality of intra-coded pictures during said processing of said plurality of intra-coded pictures in said plurality of parallel encoders.

6. The method according to claim 5, further comprising decoding said transferred processed plurality of intra-coded pictures in said plurality of previous parallel encoders before generating said plurality of parallel outputs.

7. The method according to claim 1, further comprising encoding and reconstructing said plurality of intra-coded pictures during said processing of said plurality of intra-coded pictures in said plurality of parallel encoders.

8. A method for video compression, the method comprising:
delimiting a GOP sequence into a plurality of encoding groups;
transferring said plurality of encoding groups into a plurality of parallel encoders;
processing in said plurality of parallel encoders a plurality of last predictive pictures in said plurality of encoding groups;
transferring said processed plurality of last predictive pictures to a plurality of next parallel encoders;
generating a plurality of parallel outputs based on said transferred processed plurality of last predictive pictures and said transferred plurality of encoding groups; and
assembling said generated plurality of parallel outputs into an encoded video output.

9. The method according to claim 8, wherein at least one encoding group in said plurality of encoding groups ends in at least one bidirectional-predictive picture.

10. The method according to claim 8, further comprising transferring consecutive encoding groups in said plurality of encoding groups into consecutive parallel encoders in said plurality of parallel encoders.

11. The method according to claim 8, further comprising encoding said plurality of last predictive pictures during said processing of said plurality of last predictive pictures in said plurality of parallel encoders.

12. The method according to claim 11, further comprising decoding said transferred processed plurality of last predictive pictures in said plurality of next parallel encoders before generating said plurality of parallel outputs.

13. The method according to claim 8, further comprising encoding and reconstructing said plurality of last predictive pictures during said processing of said plurality of last predictive pictures in said plurality of parallel encoders.

14. A system for video compression, the system comprising:
a delimiter that transfers a plurality of encoding groups into a plurality of parallel encoders;
said plurality of parallel encoders process a plurality of intra-coded pictures in said plurality of encoding groups;
said plurality of parallel encoders transfer said processed plurality of intra-coded pictures to a plurality of previous parallel encoders;
said plurality of previous parallel encoders generate a plurality of parallel outputs based on said transferred processed plurality of intra-coded pictures and said transferred plurality of encoding groups; and
an assembler that assembles said generated plurality of parallel outputs into an encoded video output.

15. The system according to claim 14, wherein said delimiter delimits a GOP sequence so that at least one encoding group in said plurality of encoding groups corresponds to a GOP structure.

16. The system according to claim 14, wherein said delimiter transfers consecutive encoding groups in said plurality of encoding groups into consecutive parallel encoders in said plurality of parallel encoders.

17. The system according to claim 14, wherein a controller indicates to a first parallel encoder in said plurality of parallel encoders that a first of said plurality of encoding groups is transferred to said first parallel encoder for processing.

18. The system according to claim 14, wherein said plurality of parallel encoders encode said plurality of intra-coded pictures during said processing of said plurality of intra-coded pictures.

19. The system according to claim 18, wherein said plurality of previous parallel encoders decode said transferred processed plurality of intra-coded pictures before generating said plurality of parallel outputs.

20. The system according to claim 18, wherein said plurality of parallel encoders encode and reconstruct said plurality of intra-coded pictures during said processing of said plurality of intra-coded pictures.

21. A system for video compression, the system comprising:
a delimiter that delimits a GOP sequence into a plurality of encoding groups;
said delimiter transfers said plurality of encoding groups into a plurality of parallel encoders;
said plurality of parallel encoders process a plurality of last predictive pictures in said plurality of encoding groups;
said plurality of parallel encoders transfer said processed plurality of last predictive pictures to a plurality of next parallel encoders;
said plurality of next parallel encoders generate a plurality of parallel outputs based on said transferred processed plurality of last predictive pictures and said transferred plurality of encoding groups; and
an assembler that assembles said generated plurality of parallel outputs into an encoded video output.

22. The system according to claim 21, wherein said delimiter delimits a GOP sequence so that at least one encoding group in said plurality of encoding groups ends in at least one bidirectional-predictive picture.

23. The system according to claim 21, wherein said delimiter transfers consecutive encoding groups in said plurality of encoding groups into consecutive parallel encoders in said plurality of parallel encoders.

24. The system according to claim 21, wherein said plurality of parallel encoders encode said plurality of last predictive pictures during said processing of said plurality of last predictive pictures.

25. The system according to claim 24, wherein said plurality of next parallel encoders decode said transferred processed plurality of last predictive pictures before generating said plurality of parallel outputs.

26. The system according to claim 21, wherein said plurality of parallel encoders encode and reconstruct said plurality of last predictive pictures during said processing of said plurality of last predictive pictures.

27. A method for video compression, the method comprising:
parallel processing a plurality of intra-coded pictures in a plurality of encoding groups;
generating a plurality of parallel outputs based on said parallel processed plurality of intra-coded pictures and said plurality of encoding groups; and
assembling said generated plurality of parallel outputs into an encoded video output.

28. The method according to claim 27, wherein at least one encoding group in said plurality of encoding groups corresponds to a GOP structure.

29. The method according to claim 27, further comprising transferring consecutive encoding groups in said plurality of encoding groups into a plurality of consecutive parallel encoders.

30. The method according to claim 27, further comprising indicating to a first parallel encoder that a first of said plurality of encoding groups is transferred to said first parallel encoder for processing.

31. The method according to claim 27, further comprising encoding and decoding said plurality of intra-coded pictures before generating said plurality of parallel outputs.

32. The method according to claim 27, further comprising encoding, decoding, and reconstructing said plurality of intra-coded pictures before generating said plurality of parallel outputs.

33. The method according to claim 27, further comprising assembling said encoded video output based on timing information provided by said generated plurality of parallel outputs.
